(19) United States
(12) Patent Application Publication
(10) Pub. No.: US 2020/0226706 A1
(43) Pub. Date: Jul. 16, 2020

(54) System and Method for Secure Distributed Logistics Using Automated Sorting Facilities and Dynamic Routing

(71) Applicants: Rajesh Ramarao, Madison, MS (US); Suraj Chanda, Raleigh, NC (US)

(72) Inventors: Rajesh Ramarao, Madison, MS (US); Suraj Chanda, Raleigh, NC (US)

(21) Appl. No.: 16/739,743

(22) Filed: Jan. 10, 2020

Related U.S. Application Data
(60) Provisional application No. 62/790,895, filed on Jan. 10, 2019.

(51) Int. Cl. G06Q 50/28; G06Q 10/08; B60W 60/00

(52) U.S. Cl. CPC G06Q 50/28; G06Q 10/0833; B60W 60/00256; G06Q 10/0875; G06Q 10/08355

(57) ABSTRACT

The present invention is a system and method for secure distributed package shipping logistics using automated sorting facilities and dynamic routing. In an embodiment, end-to-end security is provided by use of blockchain-based Smart Contracts. Cloud-based dynamic routing software pairs packages with available crowd shippers based upon criteria determined by the shipper. The dynamic routing software facilitates secure bailment and efficient transfer of packages with a minimum of interpersonal interaction. The system is suitable for individual or bulk package shipments, and can route for specific criteria such as “shortest travel distance,” “shortest travel time,” or “lowest cost.”

### CLAIM TO PRIORITY

This Non-Provisional application claims under 35 U.S.C. § 120, the benefit of the Provisional Application 62/790,895, filed Jan. 10, 2019, Titled “System and Method for Secure Distributed Logistics Using Automated Sorting Facilities and Dynamic Routing” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Package delivery worldwide is a multi-billion dollar industry, one that has not experienced significant change since the advent of the hub and spoke model pioneered by Federal Express based upon the famous term paper proposal of the company's founder. In the term paper, Frederick W. Smith advocated for a method of organizing package conveyance that made economic sense for urgent, as opposed to non-time sensitive, packages. Prior to the advent of Federal Express, air carriers used a routing methodology that relied on passenger route systems, unnecessarily building delays and other inefficiencies into time-sensitive package delivery.

The centralized hub approach subsequently adopted by most package delivery companies mandates that all packages shipped within a particular geographic region be routed entirely through one central hub. Packages submitted by a sender are sent directly from their point of origin to the central hub, then routed from that hub to each package's unique destination. Such a system, which may circuitously route a package for economic efficiency, is counterintuitive to the air passenger model, in which a commuter might expect his itinerary to lie along the most direct geographic route.

Packages which are so routed may be conveyed along seemingly round-about paths, but typically enjoy briefer intervals between pick-up points and destination points. Because package routes using such mid-twentieth century methodology can be configured with both time sensitivities and economic efficiencies as primary criteria, senders of urgent packages can rely upon rapid end-to-end delivery at reasonable price.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the interplay of automated sorting facilities, crowd shipping, and dynamic routing consistent with certain embodiments of the present invention.

FIG. 2 is a view of cloud based dynamic routing directed to Automated Sorting Facilities including kiosks, storage facilities, and storage partners consistent with certain embodiments of the present invention.

FIG. 3 is a process view of the overall package delivery system and method consistent with certain embodiments of the present invention.

FIG. 4 is a process view of automated sorting facility drop-off for packages to be shipped consistent with certain embodiments of the present invention.

FIG. 5 is a process view of automated sorting facility pick-up for packages having been shipped consistent with certain embodiments of the present invention.

FIG. 6 is a process view of the advertising process for the delivery system consistent with certain embodiments of the present invention.

FIG. 7 is a process view of the overall delivery network for a package delivery system and method consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “device” refers to any electronic communication device with network access such as, but not limited to, a cell phone, smart phone, tablet, iPad, networked computer, internet computer, laptop, watch or any other device, including Internet of Things devices, a user may use to interact with one or more networks.

However, unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein. 1.t should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Reference herein to “crowd shipping,” “crowd shippers,” “crowd drivers,” or the like refers to the activity of engaging crowdsourced drivers or shippers, or serves to identify crowdsourced drivers or shippers themselves, such crowdsourced individuals being understood to have had their services enlisted through solicitation of a large group of people in an online community.

Reference herein to “QR Code” refers to a machine-readable code consisting of an array of black and white squares, typically used for storing URLs or other information for reading by the camera on a smartphone.

Reference herein to an Automated Sorting Facility (ASF) refers to any of the following:
a 24/7/365 accessible indoor/outdoor kiosk with locker slots that can hold packages,
a private space of an authorized partner used for storing the packages temporarily,
a public storage space of an authorized partner used for storing the packages temporarily,
a very large container with an identification and locking mechanism that is easily accessible for tractor trailers and trucks to drop off and pickup packages.

Reference herein to a Delivery Network refers to a system and method having automated sorting facilities (ASF) and paths between the ASFs and individual transporters managed by cloud based dynamic routing (CBDR) software for distributed logistics.

Reference herein to a “Shipment Leg” refers to the package delivery between two or more ASFs within a Delivery Network.

Reference herein to a transporter may refer to any of the following:
driver partners who will accept payment for the delivery of packages,
driver employees who are hired by the company and are compensated by a delivery company,
third party parcel delivery, trucking, and moving and logistics companies who may bid for the job of delivering packages,
individual airplane pilots or ferry drivers,
drones or any hovering devices which can carry and deliver packages.

The hub and spoke model of urgent package delivery had as its genesis the failure of air carriers to adapt its passenger-route centric delivery methods to account for economic efficiencies unique to “dumb” packages. The identical travel criteria appropriate for a sentient human traveler simply did not apply to inanimate packages bearing documents, medicine, or other time-sensitive ephemera.

At the same time, providers of conveyance services did not have in their cultural or technological milieu the smart phone, with its use of GPS (Global Positioning System), and the “crowd sourced” employment that such modern technology has engendered.

Despite the obvious advantages of the hub and spoke model, its paradigm has at least one glaring pitfall: once a sender entrusts a package to the system, he or she is alienated from the package until it re-emerges at its destination point. While package tracking technologies may be able to give a sender a glimpse into the geographic progress of the package as it wends its way through the system, the sender is powerless to redirect the package mid-stream. Such re-direction (including a direction to recall the package) would be particularly useful to a sender who himself is traveling, and who may need to be reunited with a previously sent package. Re-direction would also be useful in truly maximizing the options available to an air or ground carrier to make economically efficient changes in routing based upon changed travel conditions.

Therefore, a need exists for a system and method that allows a sender to enjoy the efficiencies of package-specific routing while maximizing the sender's control over the package's ultimate destination. The innovation herein described is a system and method for distributed logistics using automated sorting facilities and dynamic routing, in a security-rich, distributed ledger-based framework.

In an embodiment, package shipment demand varies greatly based upon demand and adapting to this variability is very difficult for any delivery network. In a typical delivery network a delivery platform uses one driver to one package mapping. For a business having “x” packages to be delivered today, “y” drivers will be required. If the delivery business has “10x” packages, such as may occur during Thanksgiving, Christmas, or any holiday season, the delivery platform will not be able to provide “10y” drivers for that intermediate demand variation. In the network described herein the solution includes a combination of always open ASFs and a dynamic routing algorithm which allows for handling this varying demand. Each ASF is playing the role of a flexible node which facilitates local sorting and bundling of all the packages in the closest radius to the ASF. Transporter assignments in this network is so flexible that a trans porter may be assigned for a single pick up, multiple pickups or delivery to an ASF which may have already sorted and bundled several packages. This unique combination of a flexible ASF structure and a dynamic routing algorithm permits the network herein described to provide for the highest demand absorption for handling varying package delivery requirements over time.

In an embodiment, the instant innovation uses a combination of automated sorting facilities (ASFs) that are accessible to senders at all times of the day and all days of the year, in concert with on-demand driver partners and advanced dynamic routing software. ASFs will provide the sorting and bundling services whereas “crowd shipping” is the means of transportation. In this context, and as used herein, terms such as “crowd shipping,” “crowd shippers,” “driver partners,” or the like, include vetted individual conveyors who contract on a package-by-package basis to move individual packages from a pre-determined start point to a pre-determined destination point.

The dynamic routing algorithm utilized in this network provides numerous outputs to users and transporters for the most efficient acceptance and delivery of packages. The output from the dynamic routing algorithm provides a determination of driver assignments for transporters, the most efficient route determination for use with the network, driver payment determination calculated dynamically based upon delivery performance, Estimated Time of Delivery (ETD) for all packages, the most efficient ASF selection along the determined route, and dynamic pricing determination for package delivery that may be modified based upon delivery and route variability.

Cloud based dynamic routing (CBDR) software will make decisions to match the ASFs with the crowd shippers based on several criteria. The system makes use of a network of ASFs located at key places (gas stations, universities, apartment and home communities, malls, airports, bus stations, train stations, ship yards etc.) which can be connected by on-demand driver partners. Driver partners local to each ASF allow the network to ship in multiple possible directions. This distributed sorting facility approach avoids the costs and time delay involved in all packages being routed through one big sorting hub as in the existing hub and spoke centralized approach. One goal of the instant innovation is to leverage existing infrastructure (interstates, highways, trains, trolleys, buses, flights, trams, ships, trucks, cars etc.) and resources (crowds travelling in the same direction) to move packages from source to destination. The instant CBDR aims to incentivize driver partners who are already travelling in a particular direction rather than to incentivize drivers to go out of their natural path to deliver a package.

Such an embodiment employs a transparent approach: the destination details of any particular package are available to the driver partner and each partner can choose from the available shipments. They can also put in a request to do partial delivery and CBDR will consider these requests in driver selection.

In a non-limiting example, automated outdoor/indoor modular kiosk lockers serve as an ASF. Each ASF has several slots of different sizes (Small, Medium, Extra Large, and Extra Extra Large), with labels indicating the sizes of individual slots. There is a main module which has a kiosk server, printer and scanner embedded into it. Other modules are slot modules which communicate back to the main module. This modular approach makes it easy to vary the ASF size based on the loading reported by the CBDR.

In an embodiment, after every transaction, the ASF reports the slot status of a particular slot to the CBDR. The CBDR verifies with its own information and updates its info if its own information is not current. A periodic communication check is initiated from the CBDR to the ASF. If there is reply from the ASF, the CBDR confirms the ASF communication as healthy, but if there is no reply from the ASF, the CBDR performs a predefined number of retries.

If any of the retries receives a reply, the CBDR confirms that the ASF communication is healthy however, if all the retries fail, then the CBDR confirms the ASF communication as having failed, and reports the ASF for technical assistance. Any ASF reported for technical assistance is excluded from any customer search until the communication issues are resolved.

In an embodiment, a sender who has selected an available ASF and received from the system a QR code on his or her smart device scans the QR code at the selected ASF and the ASF sends this QR code to the CBDR for verification. If the verification is successful, the CBDR sends the system-determined slot number to the ASF, and the ASF locally opens the slot for the sender. Slot door “open” status is sent from the ASF to the CBDR. The sender would insert his or her package and close the slot door. When the sender closes the slot door, “closed” status is sent from the ASF to the CBDR.

In the event that the verification of the sender's QR code is not successful, the CBDR sends a “verification failed” message to the ASF, which would display the error message on a user screen. The ASF then prompts sender for other methods of verification, such as, but not limited to: by using a unique number displayed below the QR code, by using the sender's driver's license number, or by using account details (such as a sender's username and password).

Each verification goes through a handshake interaction with the CBDR. If the verification fails more than three times, the ASF prompts options including, but not limited to, the sender's: calling customer support at a given number or providing sender's number and having support staff call the sender. If the sender enters a phone number, the ASF sends these details to the CBDR. The CBDR sends a “wait time countdown for the support call” message to the ASF which is displayed on the ASF screen and a countdown is shown to the sender.

In an alternate embodiment, when the sender places an order for shipment, the CBDR shares the unique QR code with sender and the ASF simultaneously. Any changes to the transaction are communicated in real time with the ASF. Upon approaching the ASF, the sender scans the QR code at the ASF and the ASF locally verifies the code. In such an embodiment, no handshake request/responses with the CBDR would be needed.

If the QR code verification is successful, the ASF locally opens the slot for the sender, and the slot door “open” status is sent from the ASF to the CBDR. The sender would place the package in the slot and close the door. When the sender closes the slot door, “closed” status is sent from the ASF to the CBDR.

If the QR code verification is not successful, the ASF sends a “verification failed” message to the CBDR, the ASF displays an error message on the screen, and the ASF asks for other ways of verification, such as, by way of non-limiting example, verifying the transaction by using a unique number displayed below the QR code, verifying using the transaction by using the sender's driver's license number, or verifying the transaction using the sender's account details, such as the sender's username and password.

In this embodiment, each of the attempted verifications is performed locally at the ASF (No handshake interaction with the CBDR is needed). If the verification fails more than three times, the ASF prompts the sender to choose one of the following options: to call customer support at a given number, or to provide the sender's phone number and have a customer support representative call the sender. If the sender enters a phone number, the ASF sends these details to the CBDR, and the CBDR sends the “wait time countdown” for the support call to the ASF which is displayed on the ASF screen.

In an embodiment, scanner hardware will be integrated with the CBDR. The CBDR will be a platform that links with storage facilities bigger than kiosk lockers. An example of a storage facility is a 24 hours a day/7 days' a week-availability, monitored public storage area. For these storage locations, the ASF interaction device will be a handheld and/or wall mounted and/or standalone scanner. Each slot accessible by an operator will bear QR code labels. The CBDR will interact with the scanner in a manner similar to the aforementioned CBDR-ASF interaction explained above. Some of the key features of this ASF scanner include scanning a QR code and effecting verification with or without CBDR interaction, providing a printer to print QR code labels, and updating a QR code based upon specific slot occupancy.

In the latter scenario, when a QR code of a specific slot is scanned by the operator, that specific slot occupancy status is updated in the CBDR. This step needs the operator's confirmation. If the slot has a mechanism for providing automatic feedback to the CBDR, the CBDR automatically updates the slot occupancy information without needing the operator's confirmation.

In addition, the ASF scanner is able to communicate a “health status” to the CBDR, and provide operator feedback to the CBDR.

In an embodiment, the overall package handling process includes the sender arriving at the ASF (storage facility), the sender's QR code being scanned using the ASF scanner, the QR code's being verified, and once verified, the sender's being allowed to drop off the package in a specific slot assigned by the CBDR and confirmed by the local operator.

Once the package is dropped off, the CBDR starts advertising for local drivers to pick up the package, following several criteria to select a driver from the list of driver offers. A selected driver's QR code is scanned using the ASF scanner and the specific slot containing the package to be transported is opened by the operator. The transporter picks up the package and live tracking information is provided to the sender, the receiver and/or any third party approved by the sender.

In an embodiment, the instant innovation incorporates a dynamic routing algorithm with several general loading parameters, including:
Number of slots=n
Number of occupied slots=o
Number of unoccupied slots=n−o
Time allocated slots per locker per day in an ASF=24 time slots
Occupied time slots=24*o
Total time slots per a given ASF=24*n
ASF loading (Local/Remote) parameters
% Requirement for local load at a given ASF=L
% occupied slots with local load=X
% occupied slots with remote load=Y

n=L*n+(1−L)*n

n=n*X*L+(1−X)*L+(1−L)*n where n*X*L=% occupied

(1−X)*L=% available until the local limit exceeds

n=n*[X*L+(1−X)*L]+n*[Y*(1−L)+(1−Y)*(1−L)]

Where Y*(1−L)=% of occupied remote load

(1−Y)*(1−L)=% of unoccupied remote load

The above information will be shared with the CBDR which is programmed to decide whether this particular ASF will be used as a transition node for any particular transaction. The aforementioned loading parameters also vary based on the historical loading data at each location. For example, a locker near an airport might have higher percentage of local load compared to a remote locker that is not close to a metropolitan area, or even to a well-traveled highway.

In an embodiment, each ASF in a network of ASFs is also referenced as a node. Different type of nodes may include:
End Node—An ASF acts as an end node if it is a starting node or ending node of a transaction. In case of home pick up/drop off, the first ASF after the pickup and the last ASF before the drop off are still considered as end nodes.
Transition Node—An ASF acts as a transition node if it is neither a starting node nor an ending node in a transition. A transition node just acts as a hop/connection/bridge in the entire transaction.
Super Node—Depending on the historical loading, nodes achieve/lose this status. An ASF acts as a super node if its loading percentage is over the local limit L % for more than a specified period of time, such as one month.

In an embodiment, transaction flow may occur between two ASF's. In the event that both ASF's are end nodes, and an ASF is selected by the sender, cloud-based local ASF slot allocation algorithm software will generate a QR code for the sender which includes the following information: the source address, the Destination address, package details (Pictures, weight, size, dollar declaration, insurance option selected etc.), and ASF details including location, slot identifier, and slot timer. The local ASF slot allocation algorithm interacts with the ASF and provides the transaction drop off time and the QR code associated with the transaction. When the sender scans the QR code at the specific ASF, the specific slot door will open, and the sender prints the QR code label, sticks it on the package, places the package in the slot and closes the door.

Once the sender closes the slot door, the local ASF slot allocation algorithm starts advertising for driver partners in the ASF's vicinity (within, by way of non-limiting example, a 5-mile radius). Driver partners place requests to carry the package and provide the estimated time for pickup and drop off. The CBDR then selects a driver (based on several criteria) and shares a QR code and the location of the ASF with the driver.

Upon arriving at the ASF, the diver scans the QR code at the ASF and the slot door opens. The driver picks up the package and closes the door, whereupon the local ASF slot allocation algorithm will start providing live tracking updates to the sender, receiver and/or any other third party approved by the sender and/or receiver.

When the driver arrives at the destination ASF, he/she scans the QR code on his or her smart device and a pre-assigned slot door opens. The Driver places the package in the slot and closes the door, whereupon the local ASF slot allocation algorithm provides a QR code to the receiver along with a message that the package is available for pickup at the destination end node ASF. Sender/receiver always has an option to get the package picked up and/or dropped off from/to their home respectively.

The receiver scans the received QR code at the ASF during the pickup window and the slot door opens. He/she picks up the package and closes the door. At this time the local ASF slot allocation algorithm updates the sender, receiver and/or third party approved by sender/receiver that the transaction is complete.

In an embodiment in which one ASF is the end node and another ASF is a transition node, the sender selects the specific ASF and a time slot to drop off the package, and the local ASF slot allocation algorithm interacts with the ASF and provides the transaction drop off time and a QR code associated with the transaction. When the sender scans the QR code at the selected ASF, the local ASF slot allocation algorithm pre-assigned slot door opens. The Sender prints the QR code label, sticks it on the package, places in the slot and closes the door. One the door is closed, the CBDR starts advertising for driver partners in the ASF's vicinity (for example, within 5 miles radius).

Upon receiving an advertisement, drivers place requests to carry the package and provide the estimated time slot for pickup and drop off. The local ASF slot allocation algorithm selects a driver (based on several criteria) and shares a QR code and the location of the ASF. When the driver arrives at the ASF, the driver scans the QR code at the ASF and the slot door opens. The driver picks up the package and closes the door, whereupon the local ASF slot allocation algorithm provides live tracking updates to the sender, receiver and/or any other third party approved by the sender and/or receiver.

The local ASF slot allocation algorithm selects the transition ASF based on path selection criteria and the loading status of an ASF in the destination path, then provides path directions to the driver for the transition ASF. When the driver arrives at the destination ASF, he/she scans the QR code on his app and a pre-assigned slot door opens, whereupon the driver places the package in the slot and closes the door.

Once the driver closes the ASF door, the local ASF slot allocation algorithm starts advertising for drivers to carry the package to the next transition node or the end node and the local ASF slot allocation algorithm updates that one leg of the transaction is successfully complete.

In the embodiment in which both ASF's are transition nodes, a driver picks up a package from an end node and arrives at a transition node. When the QR code is scanned from his app, a pre-confirmed slot opens and he/she places the package in the slot. Once the slot door is closed, the local ASF slot allocation algorithm updates its status that one leg of the transaction is successfully complete and starts advertising for drivers to carry the package to the next transition node. The local ASF slot allocation algorithm-selected driver scans the QR code at the ASF and the slot door opens, whereupon the driver picks up the package and closes the door. The local ASF slot allocation algorithm provides live tracking updates to the sender, receiver and/or any other third party approved by the sender and/or receiver.

The local ASF slot allocation algorithm selects the transition ASF based on path selection criteria and the loading status of an ASF in the destination path and provides path directions to the driver for the transition ASF. When the driver arrives at the destination ASF, he/she scans the QR code on his or her smart device and a pre-assigned slot door opens, whereupon the driver places the package in the slot and closes the door. The local ASF slot allocation algorithm starts advertising for drivers to carry the package to the next transition node or the end node, and the local ASF slot allocation algorithm updates that this particular leg of the transaction is successfully complete.

In an embodiment, the local ASF slot allocation algorithm may use several ranked criteria to perform driver selection, including but not limited to: the driver who selects the quickest drop off time, the driver who selects the quickest pick up time, and the driver who is closest to a given ASF. In the event that multiple drivers who have met all other criteria equally put in requests to carry the same package, additional criteria may include preferred status of a driver, or which of the candidate drivers has bid the lowest price for his service.

In an embodiment, the local ASF slot allocation algorithm defines a default path along with multiple other paths based on the service selected. For high priority time sensitive shipments or the fastest possible option, the local ASF slot allocation algorithm does run the fastest path algorithm based on the data from all the ASF's near or at the source, the destination and all areas between the source and the destination. The local ASF slot allocation algorithm then adjusts the driver pickup window to be small and to indicate a time sensitive delivery.

The local ASF slot allocation algorithm is programmed to push a time-sensitive package towards its destination as soon as possible, prioritizing immediate departure for an interim destination over waiting for a single driver who is available to travel all the way from the source to the destination. The key to this is the effective selection of a transition point in the ASF network which has the highest (or higher rank) in the path based on the number of available transition slots in the ASF, with the higher the number of slots available, the higher the ASF transition rank. Also important in this calculation is taking into account the highest (or higher rank) in the path based on the number of drivers visiting the ASF, the number of drivers visiting the ASF and dropping off at the destination end ASF and the number of drivers visiting the ASF and dropping off at another transition ASF on the path to the destination.

In an embodiment where sender's choice is price-sensitive, the local ASF slot allocation algorithm runs the cheapest path algorithm based on the data from all the ASF's in and near the source, in and near the destination and at points in between the source and the destination. The local ASF slot allocation algorithm then adjusts the transporter window to be “flexible”, indicating price sensitivity. In such an embodiment, the local ASF slot allocation algorithm is programmed to include a price-sensitive package as part of a package bundle towards its destination.

In an embodiment where sender is sending a bulk shipment, the sender may select bulk shipment all the way (one bulk package originating from the source and to be delivered at a destination), bulk shipment at source and to be distributed to different destinations, and distributed packages shipped from different sources and to be bulked at the destination.

In an embodiment, the local ASF slot allocation algorithm provides transporters with two types of bundling options, ASF level bundling and On/Along the Way bundling. With ASF level bundling, any driver selected by the local ASF slot allocation algorithm to pick up a package from a specific ASF is provided available bundling options at that ASF. With On/Along the way bundling, the driver can provide his travel path to the local ASF slot allocation algorithm and the local ASF slot allocation algorithm provides the available bundling options at all the ASFs along the travel path of the driver.

In order to enhance end-to-end transaction security, in an embodiment Blockchain distributed ledger technology is used to allow selected partners to host the transaction ledgers. The participants in the instant innovation's blockchain will need to have credentials assigned to them before they can access any part of the blockchain. Only trusted entities can write to the blockchain. However, users, such as customers, drivers, and third parties, can verify the ledger-based transactions. In this embodiment, several ledgers will be maintained on the permissioned blockchain and will be hosted on proprietary cloud-based servers and also at preferred business partners. Access will be provided for specific ledgers for verification of transactions.

The ledgers maintained and hosted will include, by way of non-limiting example: a Customer Ledger that will capture all of a sender's information (such as the customer's name, address and a unique ID for the customer; a Transporter Ledger that will capture all of a driver's information; and a Master Ledger, that will capture all transactions relating to the transport of a package, including the sender, driver, package delivery details, tracking details, price, cost and payment details.

Use of blockchain-based ledgers will permit the launching of fully autonomous smart contracts, legal and technical mechanisms that allow pre-specified and agreed actions to occur automatically once certain conditions are met. In the instant innovation, smart contracts are used in the following manners:
1. By the Sender—when the sender wants to send a package, he or she enters all the required information such as, source and destination locations, package details, pictures of the package, etc. Once the sender submits a request, this information will form a contract between the service provider and the sender.
2. At a Kiosk—After the sender submits a request, but prior to arriving at a kiosk, a particular slot on a kiosk selected by the sender will be reserved for time specified by the sender. This will become a contract between the locker and the sender for a given period of time. Once the driver moves the package out of the box this contract expires (as the lot will be freed up).
3. By the Transporter—After the sender deposits a package in the kiosk, the service provider's backend logic will find a suitable driver to carry the package. Once the transporter, also known as a driver, agrees to carry the package, that commitment becomes a contract between the transporter and the service provider.
4. Throughout the Entire transaction: All aspects will be under an overarching contract that covers the end to end transaction. The master contract (for the transaction) will keep tract of the compliance of each sub-contract. If any one of the sub-contracts fails, the master contract will fall out of compliance.

In non-limiting examples, a number of delivery modes and service offerings are enabled by the above described delivery network. In an initial non-limiting example, the delivery network may provide a fast delivery service for time sensitive shipments. In this example, the input parameters to the dynamic routing algorithm are defined with delivery time as the prominent target. In this non-limiting example, if a package is to be delivered to a destination 200 miles away within 24 hours, the 24-hour parameter is the only binding target and all the parameters adjust accordingly to adapt to this time limit. In this instance the route determination is crucial. The fastest and most commonly traveled routes, such as interstates and highways as opposed to local roads, are given priority. After route determination, transporter assignment is given the next highest priority where several parameters are considered when selecting the transporter, including, but not limited to, the highest rated and most reliable transporter, the transporter who can pick up the package soonest, and the transporter who can carry the package for the maximum percentage of the route all go into the determination by the dynamic routing algorithm of which transporter will be offered the package. Additionally, based upon the route selection and transporter assignment, the next most crucial decision revolves around which ASFs are selected for pickup and delivery of the package. The parameters involved in the selection of the ASFs include, but are not limited to, the ASF ranked with minimum transition times, the ASF ranked with maximum transporter pickups, the ASF having high relational ranking with respect to the destination, and the ETD determination. Based on the above selections, ETD will be the final output which is continuously verified by the dynamic routing algorithm so that the time constraint is not violated.

In another non-limiting example, the delivery network may provide a delivery service that is most sensitive to price of delivery. In this example, the input parameters to the dynamic routing algorithm are defined with price as the prominent target. In this non-limiting example, if a package is to be delivered for a particular price point the transporter assignment is most crucial. In determining the transporter to be selected several parameters are considered when selecting the transporter, including, but not limited to, the transporter who opts for bundled packages, where the transporter is willing to carry additional packages for extra payment, and the transporter bidding the lowest fee to carry the package all go into the determination by the dynamic routing algorithm of which transporter will be offered the package. The next most significant parameter is the ASF selection along the delivery route. The parameters involved in the selection of the ASF(s) include, but are not limited to, the ASF ranked with high bundling package transitioning through the ASF and the ASF having a high relational ranking with respect to the destination. Additionally, based upon the transporter assignment the driver payment calculation is extremely important so that the final pricing never exceeds the pricing limit that has been established as the most prominent target.

In another non-limiting example, the delivery network may provide a delivery service that is most sensitive to customer convenience. In this example, the input parameters to the dynamic routing algorithm are defined with customer convenience as the prominent target. In this non-limiting example, if a package is to be delivered that maximizes convenience to the customer tracking of the customer is most crucial. In establishing customer tracking several parameters are considered when customer convenience is paramount, including, but not limited to, tracking the customer and having the package follow the customer, delivering the package to the ADF that is closest to the customer or to a physical address based upon customer selection, providing continuous updates to a customer at each package transition. To provide for greatest customer convenience, the customer can pick up or have the package delivered at any time during the shipping and routing of the package. The next most significant parameter is the ADF selection. ASF selection includes, but is not limited to, selecting the ADF with available slots closest to the current customer location and selecting the ASF having a high relational ranking with respect to customer location. After ASF selection, transporter assignment is the next important step, with transporters with the greatest flexibility of location preferred.

In another non-limiting example, the delivery network may provide a delivery service that may be used to transport very sensitive packages, such as medical equipment and supplies. Medical facilities which include hospitals, clinics, urgent care, and senior care have a significant need to transport/ship medicines, labs, documents, medical equipment between facilities. Such facilities also have a need to receive shipment from the vendors and supplies on an on-demand basis. Not doing so will leave gaps in the patient care and thereby increase the cost of the treatment.

In most cases medical facilities rely on traditional carriers for long distance shipments and on local couriers and even employees for local shipments. Both options have several setbacks that can potentially cause lapse in the patient care. Long distance carriers run on a fixed schedule forcing medical facilitates to work on carrier's schedule rather than patient's needs. Although courier service can provide flexibility and quicker local deliveries, courier services tend to be too expensive and have limited working hours.

The delivery network operates continually, 24 hour a day, 7 days a week, and 365 days of the year and offers flexible pickup and drop off schedules that may be specific to each facility. Artificial Intelligence (AI) capabilities of the delivery network may learn the delivery frequency and destination location patterns for package deliveries for a facility, enabling delivery schedule optimization and package consolidation based on destination. This will result in lower shipping costs for the medical facilities. With time as the delivery volume increases the algorithms will get smarter and results in incremental savings.

The delivery network may provide tracking to maintain an end-to-end strict chain of custody utilizing a blockchain capability. Because some medicines may have high dollar value, the network delivery algorithm will take the value of the medication into consideration when matching the transporter assigned to deliver the package. The transporters with the highest ratings will be assigned to such packages. While creating the delivery order for such packages, medical facilities may enter detailed information on what items are being shipped, but the QR code assigned to the transporter will only contain address information for the delivery. The rest of the information will be macerated to maintain privacy for the contents of the package being delivered.

In this non-limiting example, medical facilities may set a delivery priority for a delivery, requiring the package to be delivered within a particular timeframe. The network delivery algorithm may consider priority specified by the medical facility when determining the cost for the package delivery. Special delivery considerations may also be considered for sensitive lab specimens. Some lab specimens must be delivered within a certain time frame, if not they lose their validity and become useless. The medical facility can set time sensitivity such as, in a further non-limiting example, Delivery must be completed within two hours. In such scenarios, the network delivery algorithm may take the sensitivity into account and may avoid consolidation of packages and try to find the best route possible to meet the specified time frame. A transporter application may display a countdown clock on the display of a mobile device in use by the transporter to provide a view of remaining time the driver has to complete the delivery. As the transporter gets close to the drop off facility, the party receiving the package will receive a notification from the network delivery system to prepare them to receive the package. A delivery confirmation will be sent to the sender of the package containing a picture or short video via email or SMS.

In this non-limiting example, if a package is to be delivered for a particular price point the transporter assignment is most crucial. In determining the transporter to be selected several parameters are considered when selecting the transporter, including, but not limited to, the transporter opting for bundled packages for extra payment and the transporter bidding for the lowest payment to carry the package. Extremely crucial for this service is the route determination. The fastest and highest density routes, those that include interstates and highways as opposed to state roads, are given priority for this service.

Each of these non-limiting examples provides a detailed examination of the parameters and considerations made by the network delivery system to achieve the specified most prominent target for the delivery of specific packages.

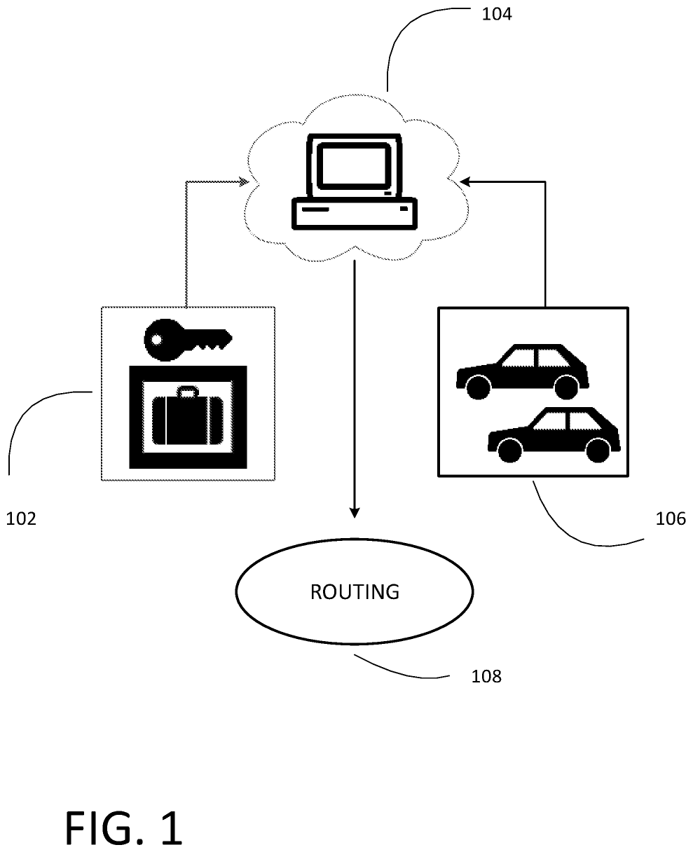

Turning now to FIG. 1, a view of the interplay of automated sorting facilities, crowd shipping, and dynamic routing consistent with certain embodiments of the present invention is shown. The Automated Sorting Facility (ASF) at 102 receives a package from sender, and communicates receipt of the package and qualities of the package (such as size and destination) to the Cloud Based local ASF slot allocation algorithm (CBAA) software at 104. The CBAA at 104 receives availability status of Crowd Shippers at 106. The CBAA software compares package quality data and availability status and calculates optimal package Routing at 108. Routing at 108 is calculated based upon sender preferences, such as “minimum transit time,” or “least expensive.”

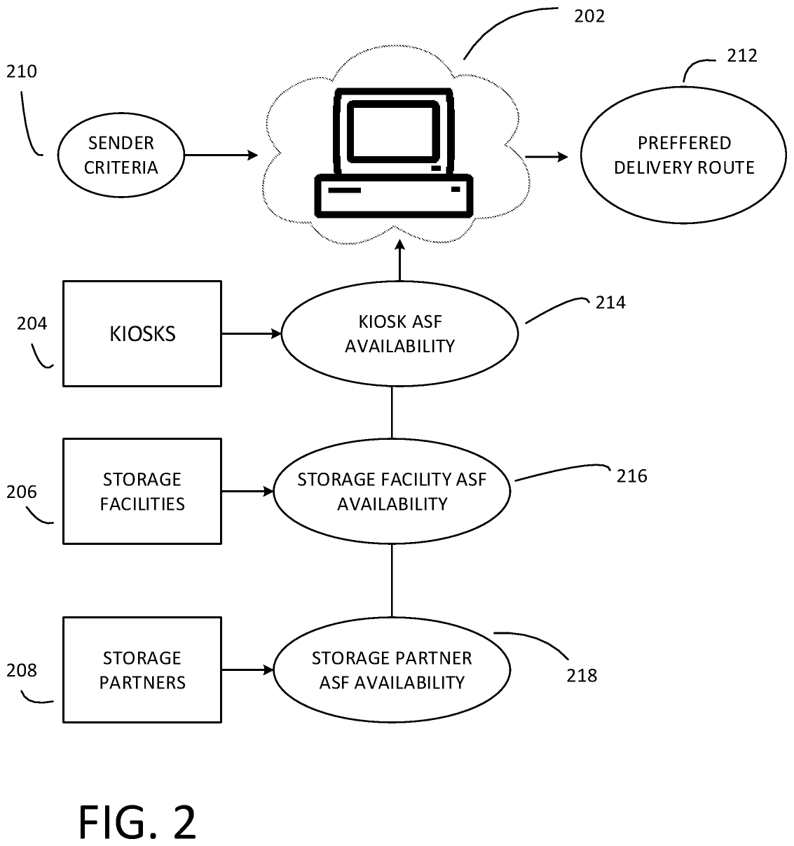

Turning now to FIG. 2, a view of cloud based dynamic routing directed to Automated Sorting Facilities including kiosks, storage facilities, and storage partners consistent with certain embodiments of the present invention is shown. Cloud Based local ASF slot allocation algorithm (CBAA) software at 202 maintains constant and/or intermittent contact with Automated Sorting Facilities (ASF) in the form of Kiosks 204, Storage Facilities 206, and/or Storage Partners at 208. Kiosks 204 may take the form of outdoor or indoor modular lockers including one or more server, printer, and scanner. Storage Facilities 206 may take the form of a human-monitored area with limited access, including a handheld, wall-mounted, or standalone scanner. Storage Partners at 208 may take the form of third-party vendor locations such as, by way of non-limiting example, restaurants, hotels, small businesses and grocery stores. CBAA software at 202 receives Sender Criteria at 210, Kiosk ASF Availability at 214, Storage Facility ASF Availability at 216, and Storage Partner ASF Availability at 218. CBDR software 202 calculates and outputs the Preferred Delivery Route at 212. Communication by CBDR software at 202 with any one of Kiosks 204, Storage Facilities 206, and Storage Partners 208 does not preclude communication by CBAA software with any other Automated Sorting Facility.

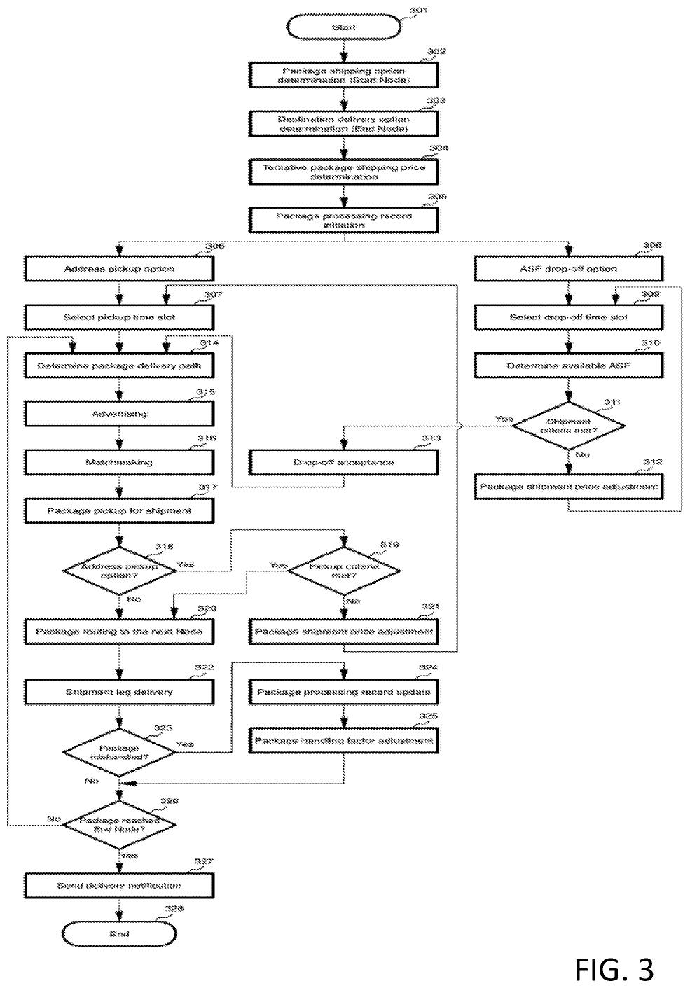

Turning now to FIG. 3, this figure presents a process view of the overall package delivery system and method consistent with certain embodiments of the present invention. In an embodiment, the sending customer may initiate the shipment in step 301 by opening the mobile based application. In step 302 the customer is provided the option to choose if package will be shipped from a home or business address. This provides the user with an address pickup option. Alternatively, the package may be dropped by the sending customer at the convenient ASF location, which provides the user with an ASF drop-off option. This selection may define the address of the Start Node in the delivery network from which the shipment will originate. In step 302 sending customer may also specify other shipment criteria, such as approximate package dimensions, weight and any specific or preferred handling instructions. The next step 303 may provide the destination delivery option where the sending customer is given the option of specifying a home, business or ASF delivery destination. The physical destination address and delivery type defines the End Node in the delivery network.

Following these inputs as well as the information about physical package characteristics, such as, in non-limiting examples, approximate weight, dimensions, and any specific handling instructions, the algorithm may utilize this information to determine a tentative package shipping price in step 304. This price may vary depending on the physical distance between Start and End Nodes, package characteristics, as well as the time of the day when shipment is intended to occur. The shipping algorithm may create a package processing record using blockchain technology in step 305 to place the exact shipping details within a block in a distributed ledger to secure the details and form the basis of a smart delivery contract should the sending customer should request this option. In this step the shipping algorithm may also generate the QR Code which will be used for package acceptance to the delivery network. If the sending customer selects the ASF drop-off option, the algorithm may follow subroutine 308 and provide the shipping customer with one or more convenient drop-off time slots (DOTS) in step 309. The time slots may be chosen in one-hour increments.

Following the time slot selection, a list of available ASFs is determined in step 310. The sending customer is given the option to choose the desired ASF location and then drop off the package within selected time slot in step 313. Once a desired ASF is selected, cloud based dynamic routing (CBDR) software reserves the slot at that ASF during the drop-off time. Before accepting the package, the processing routine verifies if shipment criteria have been met in step 311. These criteria may include at least the drop off time and weight provided by the customer in step 302. If the shipment criteria have not been met, such as, in non-limiting examples, the drop off did not occur within expected DOTS time slot, the package weight or dimensions exceed the numbers specified in step 302, the sending customer attempt to drop of the package at a different ASF than the one specified, etc., the shipment price will be adjusted in step 312. The sending customer will be redirected to step 309 where a new drop-off time slot and updated drop off criteria shall be specified. If all slots in previously selected ASF are occupied or reserved for the upcoming packages during the new DOTS, or package dimensions or weight exceed the ASF capacity, the new available ASF will be determined in step 310.

In an embodiment, if the package will be shipped from a home or business address provided for in the customer specified the address pickup option, the shipping algorithm will follow step 306 and 307 as previously described above. The sending customer may select the pickup time slot (PUTS) in step 307. Time slots will be offered in one-hour increments. The PUTS may define the time slot and timing interval when the package transporter will meet with the customer at specified address and pick up the package. Following the PUTS selection, the shipping algorithm may identify the package delivery path in step 314. This step will identify several paths which are most efficient for the pickup time slot PUTS or the drop-off time slot DOTS for the ASF drop-off option as previously indicated. Several paths may be created with different routings so as to use the flexibility of the network and optimize the overall package delivery sequence. In a non-limiting example, package transporters may not choose the most direct path from Start Node to the End Node during PUTS/DOTS as the most desirable route, but choose a shorter path to another ASF instead as being more desirable for a particular shipment. Thus, the package will enter the delivery network and move towards the End Node through sequence of shipment legs between ASF nodes, regardless of the route selected. Therefore, delivery paths identified in step 314 may include a direct path to the destination address, defined as the End Node, a path to the nearest ASF location, a path to the Transfer ASF Node, and/or a path to the Super ASF Node as routes provided to the package transporter and from which the package transporter may select so as to maximize the package transporter's ability to plan package deliveries for a particular time period. The output from the step 314 includes the location addresses of the ASF nodes as described, the route to them, as well as the compensation amounts offered for the package transporter depending on the path chosen.

In an embodiment, data is imported in step 315, where algorithm may advertise the shipping order to the individual transporters within a specified geographical area. Once advertising is successfully accomplished and a transporter candidate accepts the shipping order, the processing routine goes to matchmaking in step 316 where the transporter receives the shipping instructions. The transporter is expected to pick up the package either from the ASF or directly from the sending customer in step 317. If this is an address pickup option, the algorithm will proceed to step 319 to verify if the pickup criteria have been met, such as, in a non-limiting example, the transporter arrived to pick up the shipment within PUTS or the customer is present at the address to hand over the package within PUTS. If the pickup criteria have not been met due to transporters' late arrival, their compensation and ranking may be adjusted in step 321 to reflect the transporters efficiency or lack thereof. If the transporter arrived to pick up the package within PUTS but could not meet with the customer due to their absence, the package shipment price will be adjusted in step 321 and the processing routine may provide a sending customer with different options to select a new PUTS in step 307 and repeat steps 314-318 as previously described.

In an embodiment, if a package is being picked up from ASF or pick up criteria has been successfully met in step 319, the package may be routed to the next node in the system based on the path accepted by the package transporter in step 315. The path selected by the transporter may be any of the path directly to the destination address (End Node) or the path to ASF, Transition ASF or Super ASF Nodes located on the way to the End Node. Package transfer between any two nodes in the delivery network is defined as a shipment leg. In step 322 delivery may be achieved when the transporter reaches the node selected as the delivery node as part of the package routing. The transporter is expected to physically deliver the package to the receiving customer if the package has arrived at the End Node with home or business address, or to physically drop off the package at the ASF if current shipment leg ends at an ASF location. Following the physical drop-off, in step 323 the transporter will be requested to specify if the package suffered any damage during the shipment. If the package was mishandled, the package processing record may be updated in step 324 followed by the transporters rank update in step 325.

In an embodiment, if the currently selected shipment leg delivers a package to the End Node, the processing routine may go through step 326 to 327, where the package processing record may be updated and delivery notification may be sent to both sending and receiving customers. If the currently selected shipment leg does not deliver a package to the End Node, the processing routine will come back to step 314 to re-evaluate the package delivery path for the next shipment leg and repeat steps 315-326 as previously described. Steps 314-326, as herein presented, are repeated until package is confirmed as reaching the End Node.

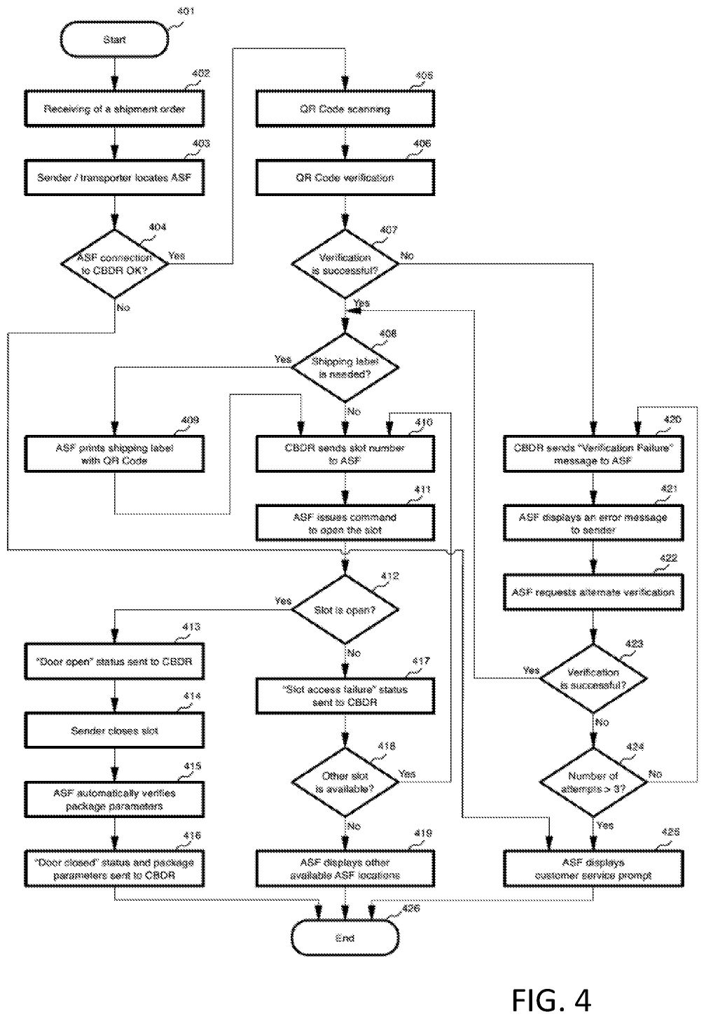

Turning now to FIG. 4, a process view of automated sorting facility drop-off for packages to be shipped consistent with certain embodiments of the present invention is shown. In an embodiment, the ASF drop-off subroutine in step 313 is shown in FIG. 4. This subroutine will also be used in step 322 when shipment leg delivers package to the ASF. After receiving the shipment order with ASF location and QR Code for ASF access in step 402, the sending customer, or package transporter, may locate the selected ASF in step 403. Every ASF in the delivery network continuously monitors its connection to the CBDR software. If the connection to the CBDR is lost, the ASF will not be able to accept and process the package. When connection to the CBDR is lost the system at step 404 may redirect the drop-off subroutine to step 425, where customer service prompt may be displayed on the ASF screen. During normal operation, when the network connection between an ASF and CBDR software is healthy, the ASF will be ready to scan QR Code in step 405.

The QR Code is generated as part of the package processing record initiation in step 305 and may be sent to the sending customer or package transporter along with a shipment order in step 402. In order to access the slot for the package during drop-off procedure, the QR Code must be physically scanned at the ASF location in step 405. Following the QR Code scanning, the scanned code may be verified in step 406. If the code verification is successful, the software algorithm may go through step 407 to step 408, where the sending customer may be asked if a shipping label is needed for those shipments for which a shipping label has not yet been generated. The shipping label with QR Code is essential for the package processing through the delivery network. If shipping label was not printed and attached to the package earlier, the ASF will print the label in step 409 for the senders' convenience. The sender may then attach the printed shipping label to the package.

Following steps 408 and 409, CBDR software sends the slot number to the ASF in step 410. This number was previously reserved for this ASF in step 310. After receiving a slot number from CBDR software, the ASF issues a command to open the slot in step 411. If a slot opens, the algorithm goes to step 413 through step 412 and updates the CBDR shipment status with the “Door open” status. The sender or package transporter may then place the package in the slot and closes the slot in step 414. The ASF software verifies the physical package parameters (such as weight and approximate dimensions) in step 415 and sends door closed status with verified package parameters to the CBDR software in step 416. Following step 416 the drop-off subroutine is completed in step 426.

In an embodiment, the drop-off subroutine may include contingency scenarios. In a non-limiting example, if an ASF slot does not open after the open command has been issued in step 411 due to ASF hardware failure, the shipment algorithm proceeds to step 417. The “Slot access failure” status will be sent to the CBDR software, where the affected slot will be excluded from the delivery network and any other package processing until a service crew has repaired the hardware problem and placed the slot back in service. Following step 417, the shipment algorithm may locate another available slot at the ASF to accept the package in step 418. Availability is confirmed if there is an empty slot and it is not reserved for any upcoming package during current DOTS. If no other slot at this ASF is available, the ASF software may display other available ASF locations in the area in step 419, where customer can confirm desired ASF and drop off the package there.

In an embodiment, if QR Code verification failed in step 407, the CBDR software may send a “Verification Failure” message to the ASF in step 420. The ASF software may display an error message to sender in step 421 and request an alternate verification in step 422. If verification is successful, a subroutine of the ASF software may proceed to step 408. If not, the ASF software may allow two more verification attempts through steps 424, 420, 421, 422, 423 before going to step 425 if all verification attempts failed.

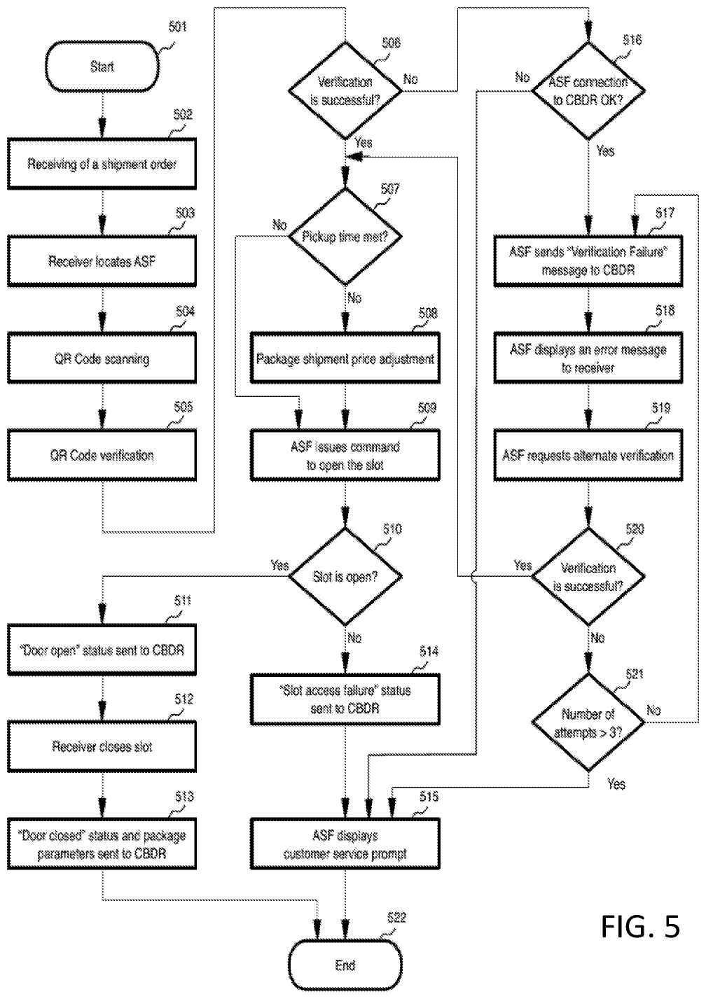

Turning now to FIG. 5, a process view of automated sorting facility pick-up for packages having been shipped consistent with certain embodiments of the present invention is shown. In an embodiment, the ASF package pick up subroutine is shown in FIG. 5. This subroutine is employed by the CBDR software where a shipped package is picked up from ASF by the transporter to be routed to the next node in the delivery network. This procedure may also be followed by a receiving customer if the End Node for the package is ASF location as the destination address instead of a home or business address. After receiving a shipment order in step 502, the receiver, whether a package transporter or receiving customer, may locate the ASF in step 503. The receiver may scan the QR Code to access the ASF slot containing a package in step 504. The QR Code is provided with a shipment order in the mobile application. The ASF may verify the QR Code in step 505. Unlike in the drop-off procedure, the ASF can verify the QR Code locally without interrogating CBDR software. This is possible because the ASF has the QR Code and other information associated with the package locally available as well as the slot number where package is stored.

If the verification is successful, the routing algorithm goes through step 506 to step 507, where the algorithm may verify that the package pick-up time provided in the shipping order has been met. If a package transporter picked up this package later than expected, the routing algorithm will go to step 508 where it may adjust the transporters' compensation and rating. Following steps 507 or 508 the ASF may issue a command to open the slot containing the package. When the slot opens, the “Door open” status may be sent to the CBDR software in step 511.

At that point in time the receiver may pick up the package and close the slot in step 512. Once door is closed, the “Door closed” status is sent to the CDBR software. If during pick up procedure ASF does not have network connection to CBDR software, the ASF management routine still will be able to verify receiver locally and open the slot with the package. In this instance “Door open” and “Door closed” statuses will be sent to CBDR software as soon as network connection is reestablished. When received by the CBDR software, the updated status for each “Door open” and “Door closed” indication will clear the received package from the ASF slot and make it available for other packages in the delivery network.

In an embodiment, similar to drop-off subroutine, the pick-up algorithm subroutine includes contingency scenarios. If the ASF slot does not open due to a hardware failure, ASF management routine may send a “Slot access failure” status to the CBDR software in step 514 and display a customer service prompt in step 515. The “Slot access failure” status will exclude this ASF slot from the delivery network until a service crew has an opportunity to fix the hardware problem.

In an embodiment, if the QR Code verification is not successful in step 505, a verification algorithm may seek to verify whether the ASF has a network connection to the CBDR software in step 516 and sends “Verification failure” message to CBDR software. The error message is displayed to the receiver on any mobile device or a display associated with a network connected device and visible to the receiver of the package in step 518 and may request an alternate verification in step 519. If the QR code verification is successful, the subroutine will proceed through step 520 to step 507 to verify the package pick-up. If not, receiver will be offered two more verification attempts through steps 517-520 before algorithm may exit the pick up subroutine in steps 515, 522.

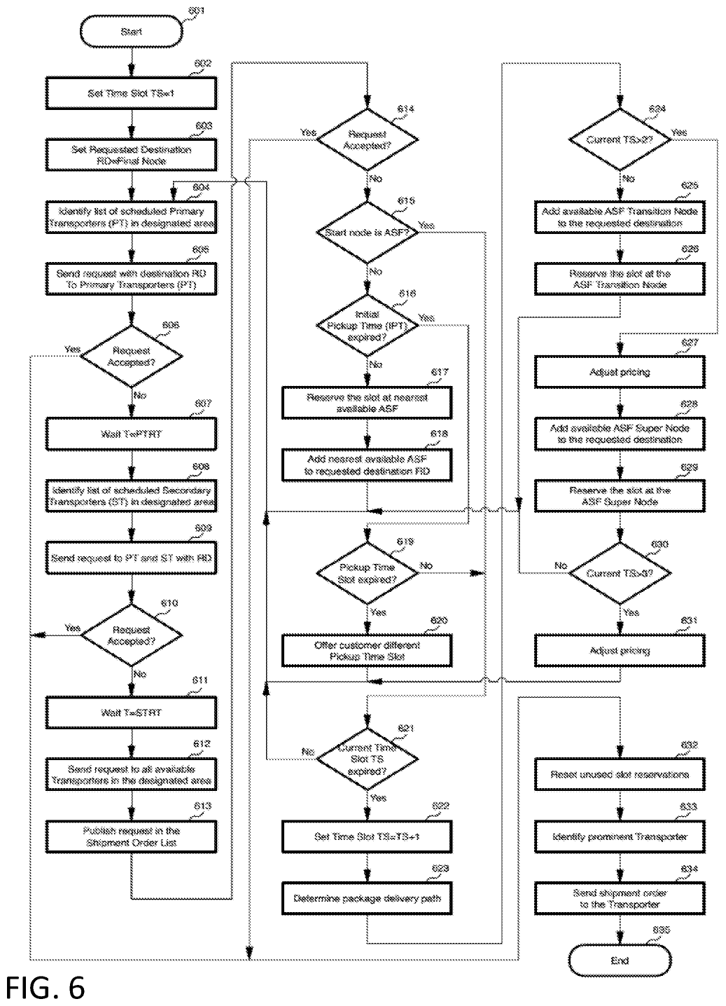

Turning now to FIG. 6, a view of the advertising process for the delivery system consistent with certain embodiments of the present invention is shown. The advertising subroutine of step 315 is shown in FIG. 6. In a non-limiting example, the package processing time through the network may be split into a number of time slots. In this particular example the time is split into four time slots (Time Slot 1-4). The duration of individual time slots may vary depending on number of customers, number of transporters and ASFs located in the geographical area, and other parameters that may be specified during operation of the system.

In an embodiment, the time slots may be introduced to the algorithm to achieve flexibility of the delivery network, dynamically manage the priority for the package depending on how long the package has been present in the network, and also better estimate and manage the odds of delivery as being accomplished within certain time frame. In this exemplary embodiment, a first time slot may be initiated as shown in step 602. The advertising subroutine aims to find a candidate transporter to deliver package from the current location of the package to the requested destination (RD). In ideal circumstances a package can be delivered directly to the destination address, which may be specified as the End Node in the delivery network, bypassing the network of ASFs to offload the routing software for other packages. Therefore, during the first time slot, which may be when the package is first introduced to the delivery network, the routing algorithm may set only a Final Node as a requested destination in step 603. At 604 the routing algorithm may next identify the list of package transporters signed up as Primary Transporters (PT) in the designated area associated with time slot 1. When signing up as a PT through the mobile based application, an incumbent PT selects the day and time when they will be available to deliver packages. The designated area associated with each PT may be determined based on the present package location.

In an embodiment, once the list of Primary Transporters is identified, the routing algorithm goes to step 605 and sends a request to all PTs on the list specifying the requested destination, miles to be driven, and compensation for this delivery. During time slot TS1 the requested destination is only the final address, which is specified as the End Node in the delivery network. If request is accepted by any of the PTs, the routing algorithm goes to step 632 and resets any unused ASF slot reservations for this package. At 633 the routing software may define which transporter shall be employed should multiple PTs accept the delivery request. The determination is based on the PTs' ranking and current time slot. As a general rule, the routing algorithm will select PTs with lower rank during time slots 1 or 2, when the delivery network still has enough time to process package. The PTs with higher rank will be selected if current time slot is 3 or 4, when the delivery network is running out of time to meet the scheduled delivery time and the package should be delivered as soon as possible. This approach is intended to manage the workflow between the transporters with different ranks and provide the ability to increase the ranking of more efficient and reliable PTs.

In an embodiment, the transporter ranking is calculated based on number of factors including number of packages delivered successfully, number of packages picked up and dropped off at a node with a current package, number of packages picked up/dropped off in a region (x mile radius or zipcode), types of package picked up, number of times accepted the assigned shipping orders, driving record, ASF handling issues, delayed pick up/drop off history, number of damaged packages, off the track driving, regular updates on any driving citations, number of times speed limit exceeded, number of hours active per month, and a PT ranking based on customer feedback. Once a preferred PT is identified, the algorithm sends the shipping order to the transporter in step 634.

In an embodiment, if none of the PTs contacted accepted the shipping request in step 606, the routing algorithm may wait for the period of Primary Transporter Request Time (PTRT) in step 607 before going to step 608, where list of Secondary Transporters (STs) will be identified in the designated area for time slot 1. When signing up as a Secondary Transporter through the mobile based application, an incumbent ST selects the days and times when they will be available to deliver packages if Primary Transporters are occupied with the workflow.

Once list of STs is identified, the routing algorithm may send the shipping request to all Primary and Secondary Transporters in the area in step 609. If the shipping request is accepted by any PT or ST, the process proceeds from step 610 to steps 632-635. If no PT or ST accepts the shipping request, the subroutine may wait for the timeout Secondary Transporter Request Time (STRT) in step 611. If the shipping request has still not been accepted by a PT or ST by the time the STRT times out, the routing algorithm may send the shipping request to all transporters in a wider designated area in step 612 and then publish the shipping request in the Shipment Order List at 613, which can be accessed by any transporter in the area once their mobile based application is switched on-line and the shipping request is received.

In an embodiment, if the shipping request is still not accepted by any transporter, the shipping algorithm checks to determine if the Start Node is an ASF in step 615. When the Start Node is a home or business address, the shipping algorithm checks to determine if the initial pick up time (IPT) is expired in step 616. The IPT time is needed for the delivery network to find a transporter who is willing and able to deliver a shipped package directly to the End Node bypassing all other ASFs. If none of the transporters has accepted delivery at the End Node, the shipping algorithm will have to find the transporter who can pickup the package directly from the customer before PUTS is expired and deliver the package to any AFS for further processing. In a non-limiting example, the IPT time generally could be half of the pickup time slot defined by the shipping customer in step 307. If the IPT is not expired, the shipping algorithm at 617 reserves a slot at the ASF nearest to the sending customer and then adds this ASF location to the requested destination in step 618. The shipping algorithm iterates from step 604 to continue to locate a PT, ST, or any other transporter capable of picking up and delivering the shipped package, but now two destinations will be advertised to the transporters—the End Node and nearest ASF Node. If IPT time is expired, the shipping algorithm checks to determine whether the pick up time slot (PUTS) time is expired in step 619. Expiration of PUTS would mean the package is not picked up from the shipping customer, therefore the shipping algorithm will provide the customer the option of selecting a new PUTS in step 620.

At Step 621 the shipping algorithm monitors the ASF to determine whether the current time slot is expired. If so, the next time slot is applied by the shipping algorithm in step 622 and the package delivery path reevaluated for the new time slot in step 623. If this is a Time Slot 2 the algorithm adds an ASF Transition Node to the list of requested destinations in step 625 and reserves the slot in this ASF in step 626. The process iterates from step 604, but now three destinations will be advertised—the End Node, nearest ASF Node and ASF Transition Node. In this fashion the shipping algorithm continues to advertise for transporters on a wider and wider basis, updating location, pick-up times, compensation, and delivery times until a shipment is successfully picked up and delivered to a desired destination.

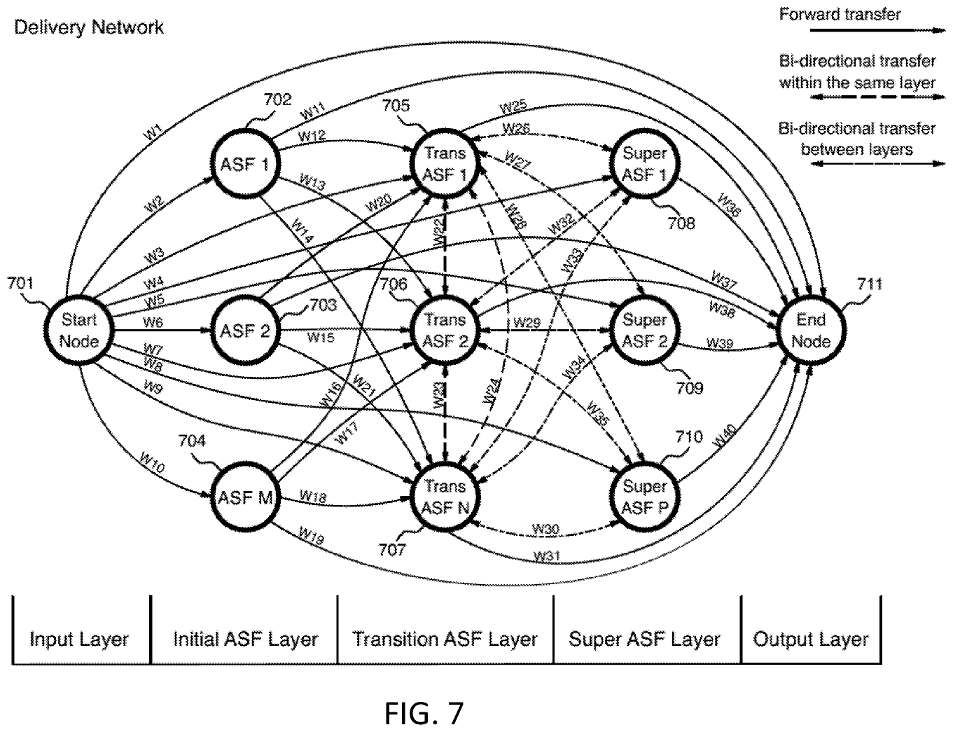

Turning now to FIG. 7, a view of the process of the overall delivery network for a package delivery system and method consistent with certain embodiments of the present invention is shown. The package delivery path determination subroutine called in steps 314, 623 identifies the most efficient way to process a package through the delivery network from package pick-up through package delivery to the specified destination address. To determine the path for the next shipment leg, the shipping algorithm composes the network as shown in FIG. 7. This network includes several layers of nodes and connection links between them. Connection links represent the shipping legs. The input layer includes only a Start Node 701 representing the ASF, home or business address from which the shipping request originates. The Initial ASF layer includes M ASF Nodes 702-704 located close to the Start Node. Transition ASF Layer includes N ASF Transitions Nodes 705-707 typically located next to the busy streets or highways. Super ASF Layer includes P ASF Super Nodes 708-710. The Output Layer includes only a single End Node 711 representing destination address or destination ASF. The network is composed using the following principle—Start Node 701 may be linked to any or all nodes in the network, meaning that package can be transferred between them. The ASF Nodes 702-704 in the Initial ASF Layer may be linked to all Transition ASF Nodes 705-707 in the next Transition ASF Layer as well as to the End Node 711. Transition ASF Nodes 705-707 may be linked to each other within Transition ASF Layer as well as to all ASF Super Nodes 708-710 in Super ASF Layer and to the End Node 711. Super ASF Nodes 708-710 may be linked to the End Node 711 as well as back to the ASF Transition Nodes 705-707.

In an embodiment, the number of the nodes in each layer as well as the addresses associated with each node are identified based on the distance between Start Node and End Node, number of available ASFs, population density of the area, etc. Each link represents a possible package transition between the nodes. Depending on the criteria used to evaluate the most efficient path, each node and connections between them have statistically acquired data. In a non-limiting example, if shipping time is the most important criteria for the package, each node will have an average processing time value for the current time slot. Once nodes have fixed locations, all connection between them are also constant and have weights W1-W40 representing the average time for package delivery between the nodes. Summarizing the node processing time constants and weights W1-W40 the CBDR software will identify the smallest sum representing the fastest path for the current time slot among all possible paths.

In an alternative embodiment, when the most important shipping criteria is cost, the CBDR software will utilize statistically acquired ASF storage cost data for all nodes in the network and replace weights W1-W40 with the average transfer cost. Summarizing these values, the CBDR software can identify the least expensive path represented by the smallest sum.

In an embodiment, the determination of the node type (ASF Node, ASF Transition Node, ASF Super Node) is based on the automatic self-ranking using the following criteria:
Number of people visiting the node;
Number of transporters visiting the node;
Number of customers visiting the node;
Busiest time of the day;
Number of packages going through the node;
Number of packages with the node as a Start Node;
Number of packages with the node as End Node;
Number of packages with the node as a Transition Node.

To balance the load through the delivery network the CBDR software may choose nodes with a lower ranking to process package during Time Slot 1 or 2 and nodes with higher ranking to process packages during Time Slot 3 or 4.

While certain illustrative embodiments have been described, it is evident that many alternatives, modifications, permutations and variations will become apparent to those skilled in the art in light of the foregoing description.

We claim:

1. A system for distributed logistics, comprising:
a data server;
one or more nodes in data communication with the data server;
receiving a package authorized for shipment to a recipient at any of the one or more nodes;
transmitting a request for authorized transporters local to the node;
selecting an authorized transporter based at least in part upon sender-provided criteria;
the selected authorized transporter taking secure possession of the package from a selected one of the one or more nodes;
providing current package-tracking updates to at least the sender of the package;
storing package-shipment details associated with said package to a distributed ledger;
creating an autonomous contract for execution of delivery of said package to said recipient; and
delivering the package to the recipient.

2. The system of claim 1, where the one or more nodes are automated indoor/outdoor kiosks.

3. The system of claim 2, where the automated indoor/outdoor kiosks are composed of modules.

4. The system of claim 1, where the one or more nodes are end nodes, transition nodes, or super nodes.

5. The system of claim 1, where the receiving the package and the taking secure possession of the package are accomplished at least in part by electronic verification.

6. The system of claim 5 where the electronic verification includes use of a QR code.

7. The system of claim 1 where the selecting an authorized driver and the delivering the package to the recipient are algorithmically optimized.

8. The system of claim 7 where the algorithmic optimization uses at least in part sender-provided criteria.

9. A method for optimizing distributed logistics, comprising:
establishing one or more nodes in data communication with a data server;
receiving a package authorized for shipment to a recipient at any of the one or more nodes;
transmitting a request for authorized transporters local to the node;
selecting an authorized transporter based at least in part upon sender-provided criteria;
the selected authorized transporter taking secure possession of the package from a selected one of the one or more nodes;
providing current package-tracking updates to at least the sender of the package;
storing package-shipment details associated with said package to a distributed ledger;
creating an autonomous contract for execution of delivery of said package to said recipient; and
delivering the package to the recipient.

10. The system of claim 9, where the one or more nodes are automated indoor/outdoor kiosks.

11. The system of claim 10, where the automated indoor/outdoor kiosks are composed of modules.

12. The system of claim 9, where the one or more nodes are end nodes, transition nodes, or super nodes.

13. The system of claim 9, where the receiving the package and the taking secure possession of the package are accomplished at least in part by electronic verification.

14. The system of claim 13 where the electronic verification includes use of a QR code.

15. The system of claim 9 where the selecting an authorized driver and the delivering the package to the recipient are algorithmically optimized.

16. The system of claim 15 where the algorithmic optimization uses at least in part sender-provided criteria.
